(19) United States
(12) Patent Application Publication
(10) Pub. No.: US 2010/0157580 A1
(43) Pub. Date: Jun. 24, 2010

(54) SUSPENSION BRACKET FOR LIGHTING FIXTURES

(75) Inventors: Marvin Feig, Northbrook, IL (US); Alexander Kowalenko, Inverness, IL (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: Good Earth Linghting Inc.

(21) Appl. No.: 12/711,740

(22) Filed: Feb. 24, 2010

Related U.S. Application Data
(63) Continuation of application No. 11/975,099, filed on Oct. 17, 2007.

(51) Int. Cl. F21S 8/04; F21S 8/00; F21S 6/00

(52) U.S. Cl. 362/147; 362/432; 362/257; 362/263

(57) ABSTRACT

A suspension bracket for a lighting fixture of the type used in residential or commercial buildings. The bracket provides a center mounting point for a shade while allowing a lighting element to be positioned in the center of the fixture, rather than to the side of the shade mounting point.

### RELATED APPLICATION

This application is a continuation of U.S. patent application Ser. No. 11/975,099 filed Oct. 17, 2007, which is hereby incorporated by reference herein.

### TECHNICAL FIELD

The present invention relates generally to light fixtures, and particularly, to structure-mounted light fixtures.

### BACKGROUND

Decorative light fixtures are known in the art. Decorative fixtures serve to conceal unsightly electrical components and soften the otherwise harsh light from a bare bulb. Many fixtures feature a shade attached to the fixture by means of a threaded rod and finial. In ceiling-mounted applications in particular, this threaded rod commonly extends through the center of the fixture, passes through an opening in the center of the shade, and receives a finial to secure the shade. In these designs, a plurality of incandescent light bulbs are arranged circumferentially around the central support to provide symmetrical distribution of light. However, when only one bulb is used in these ceiling fixtures, the light distribution is asymmetrical, and does not look appealing.

With the advent of energy-efficient fluorescent lamps; oftentimes, only one lamp is needed to provide the same light output as several conventional incandescent bulbs. When a single lighting element is used, fixture designs utilizing a central support rod mounting point are often not appropriate. For example, if a fluorescent lamp is used, the socket for the lamp and the need for a ballast make it necessary to locate the lamp nearer the center of the fixture. To maintain a low profile and save space in a conventional fixture, the bulb is usually located off to one side. When a single lighting element is used in a conventional fixture, the lighting in the fixture will be uneven; the side of the fixture on which the lamp is located will be bright, and the other will be dark. Use of several elements to balance the lighting not only defeats the cost saving purpose of using single lamps, but also results in a fixture that gives off far too much light.

A need, therefore, exists for a fixture that will accommodate a single lighting element, centrally located, while emitting light evenly and maintaining a conventional outward appearance using conventional external hardware.

### BRIEF DESCRIPTION OF THE DRAWINGS

For the purpose of illustration, there are shown in the drawings embodiments that are presently preferred; it being understood, however, that the embodiments are not limited to the precise arrangements and constructions particularly shown. In the drawings:

FIG. 1 is a side view of a lighting fixture of the prior art.

FIG. 2 is a front view of the prior art fixture of FIG. 1.

FIG. 3 is a front view of a lighting fixture incorporating a bracket according to the illustrated embodiment.

FIG. 4 is a side view of the fixture of FIG. 3.

FIG. 5 is a front view of the bracket shown in FIG. 3.

FIG. 6 is a side view of the bracket of FIG. 5.

### DETAILED DESCRIPTION OF THE DRAWINGS

Referring now to the drawings, a suspension bracket is shown for use in a light fixture. As will be discussed below, the bracket allows use of a single lighting element, such as an incandescent lamp, or compact fluorescent lamp, in a fixture that presents a conventional outward appearance.

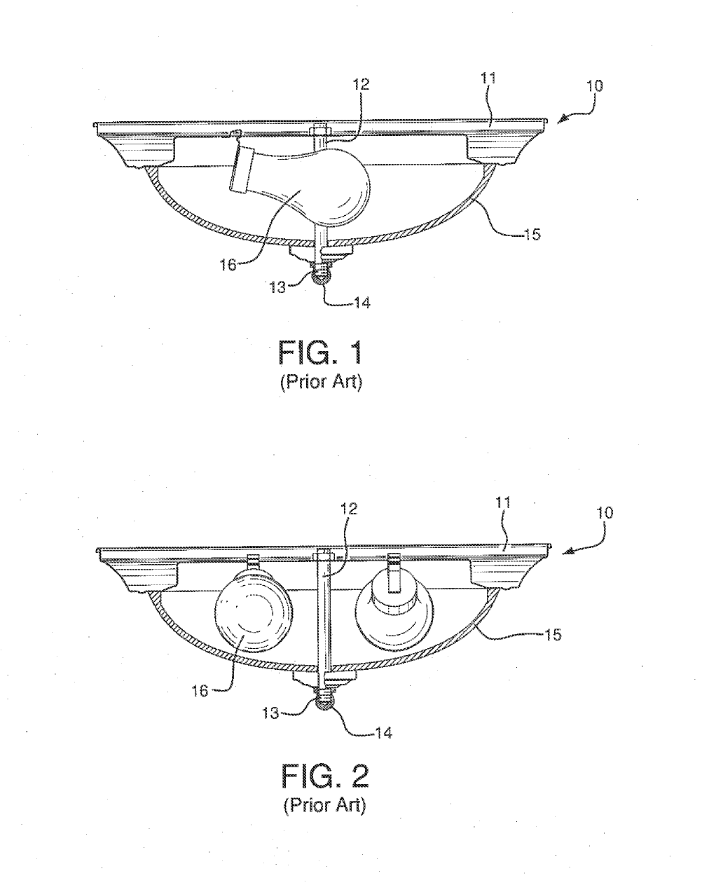

FIGS. 1 and 2 depict an example of a conventional light fixture 10. The base 11 is typically mounted to the ceiling of a building. Extending from the base is a support rod 12, which typically features a threaded end 13. The threaded end receives a finial 14, securing a shade 15 at a point typically near the center of the shade. The shade hides the bulbs 16 and serves to soften and diffuse the light emitted.

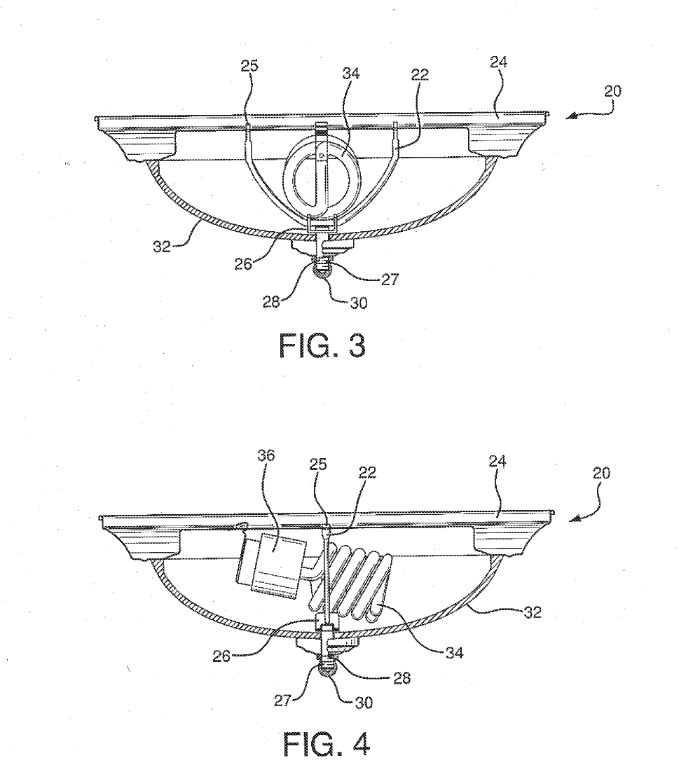

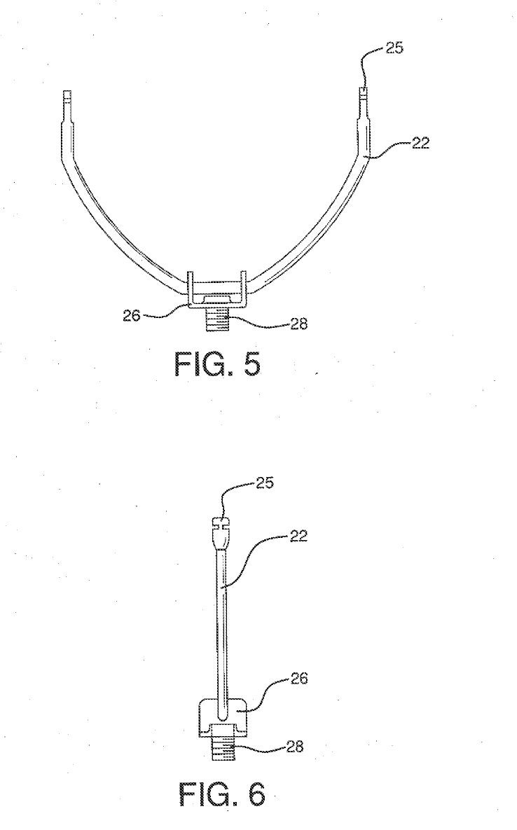

FIGS. 3 and 4 depict a lighting fixture incorporating a bracket instead of a support rod. The lighting fixture 20 is preferably mounted to the ceiling of a structure, although it is contemplated that the fixture may be mounted in a number of orientations, including vertically on a wall. Bracket 22 is fixedly mounted to base 24 at at least one, and preferably two, anchor point or points 25. The anchor points may utilize any means known in the art, including snap-in fittings or threaded connections. In the illustrated embodiment, the bracket extends around the lighting element 34. “Around” as used herein means “about at least a part of the circumference of.” While the bracket is preferably arcuate in shape, one of ordinary skill in the art will observe that the bracket may take on many shapes, including a linear or angular shape. A shade receiving member 26, such as a saddle, is mounted on the bracket at a point removed from the anchor point or points, preferably approximately in the center of the bracket. The saddle also preferably includes engagement means 27. The engagement means preferably include a rod or nipple 28, which is preferably threaded so as to engage a threaded finial 30, although other means of attachment, such as channels, keyways, pins, snaps, and even physical or chemical bonding may be used. In a preferred embodiment, the saddle includes an integral nipple; however, it is contemplated that the saddle may include a threaded hole adapted to engage a threaded male end of a finial. Alternatively, the shade may attach to the shade receiving member or saddle directly, without use of a finial; for example, the shade may be glued or otherwise bonded to the saddle. Additionally, while it is preferable that the bracket forms an arcuate shape as seen in FIGS. 4 and 5, it will be appreciated that the bracket may take a variety of shapes and include any number of anchor points.

As seen in FIGS. 3 and 4, the shade 32 is secured to the fixture by the engagement of the finial 30 to the saddle 26. The shade serves to impart a decorative appearance to the fixture, and also softens and diffuses the light provided by the lighting element. Shades such as the one employed in the present invention are known in the art, and may be constructed of a number of materials, including glass, fabric, and plastic. The shade may be transparent, but is preferably translucent so as to prevent an observer from discerning at least some of the interior components of the fixture, while allowing light to pass through. The fixture illustrated herein preferably maintains a conventional outward appearance in normal use, in which the shade is secured to the fixture at a point in the center of the shade.

FIGS. 3 and 4 also include lighting element 34, which is preferably a compact fluorescent lamp. While a fluorescent lamp is preferred, it will be understood by those of ordinary skill in the art that a number of other types of lighting sources may be used, including incandescent light bulbs, halogen bulbs, and even light-emitting diodes. The light source is held in position and powered by socket 36. The socket is connected to a power circuit (not shown), and is adapted to hold and power the particular type of element chosen for use in the fixture.

It will be apparent to those skilled in the art that various modifications and variations can be made in the configuration of the present invention without departing from the spirit or scope of the invention. It is intended that the present invention cover such modifications and variations provided they come within the scope of the appended claims or their equivalents.

What is claimed is:

1. A suspension bracket for a lighting fixture, comprising:
a support member adapted to be mounted to a base at at least one anchor point, the base being mountable on a structure, the support member including a shade receiving member disposed thereon for attaching a shade to the lighting fixture, the support member having a shape enabling it to be at least partially disposed around the lighting element.

2. The bracket of claim 1, wherein the support member includes two anchor points and the shade receiving member is disposed on the support member at a point between the anchor points.

3. The bracket of claim 1, wherein the shade receiving member is adapted to receive a means for securing a shade.

4. The bracket of claim 3, wherein the means for securing a shade is a finial.

5. The bracket of claim 1, wherein the support member is substantially arcuate in shape.

6. The bracket of claim 1, wherein the shade receiving member includes a threaded nipple.

7. The bracket of claim 1, wherein the shade receiving member includes a threaded hole adapted to receive a nipple.

8. A lighting fixture including the bracket of claim 1, wherein the bracket is mounted to a base adapted to be mounted to a structure.

9. The lighting fixture of claim 8, including a socket adapted to hold and power a lighting element.

10. The lighting fixture of claim 8, including a shade.

11. The lighting fixture of claim 9, wherein the lighting element is a fluorescent lamp.

12. The lighting fixture of claim 9, wherein the lighting element is an incandescent bulb.

13. The lighting fixture of claim 8, wherein the support member is substantially arcuate in shape.

14. The lighting fixture of claim 13, wherein the lighting element is disposed inside the arc formed by the support member.

15. The lighting fixture of claim 14, wherein the lighting element's longitudinal axis is located substantially perpendicular to the plane of the arc formed by the support member.

16. The lighting fixture of claim 8, wherein the base is attached to a ceiling.

17. The lighting fixture of claim 8, wherein the base is attached to a wall.

18. A lighting fixture, comprising:
a socket supported by a base being mountable on a structure, the socket being adapted to hold and power a lighting element;
an arcuate support member having two ends and means at each end for attaching it to the base;
a shade receiving member disposed on the support Member at a point between the ends of the support member;
a shade adapted to conceal the support member and lighting element; and
a finial adapted to removably secure a shade to the shade receiving member.

19. The lighting fixture of claim 18, wherein the lighting element is a fluorescent lamp.

20. The lighting fixture of claim 18, wherein the shade receiving member includes a hole adapted to receive a threaded portion extending from the finial.

21. The lighting fixture of claim 18, wherein the shade receiving member includes threaded portion extending therefrom to engage a corresponding threaded opening in the finial.
